(19) United States
(12) Patent Application Publication
(10) Pub. No.: US 2015/0156997 A1
(43) Pub. Date: Jun. 11, 2015

(54) Trawling net with improved Cod-end for catching shrimps

(71) Applicant: Guy Leblanc, Carleton (CA)

(72) Inventor: Guy Leblanc, Carleton (CA)

(21) Appl. No.: 14/102,785

(22) Filed: Dec. 11, 2013

(51) Int. Cl. A01K 75/00; A01K 73/02

(52) U.S. Cl. CPC A01K 75/00; A01K 73/02

(57) ABSTRACT

A trawling net with improved Cod-end for catching shrimps has an outer net having a uniform thread gauge, and which is knotted such that square-shaped openings are formed in a side-by-side uniform pattern. An inner net having a uniform thread gauge that is smaller than the outer net thread gauge, and which is knotted such that lozenge-shaped openings are formed in a side-by-side uniform pattern, wherein the lozenge-shaped openings are each formed having an area that is smaller than an area defined by each the square-shaped opening, and wherein the inner net is placed upon an inner surface of the outer net forming the improved trawling net, such that the trawling net is thereby adapted to catch smaller fish and marine life than the outer net alone.

### FIELD OF THE INVENTION

The present invention relates generally to commercial fishing but more particularly to a cod-end for catching shrimps.

### BACKGROUND OF THE INVENTION

Trawling fish nets are generally funnel shaped, starting with a wide opening and tapering off towards what is known as the cod end. The net is knotted so as to have the threads forming lozenges. Different types of thread sizes are used as well as different sizes of lozenges, depending upon the types and sizes of fish one want to catch. There is also the overall shape of the net which can change. The shape and most importantly the size of the lozenges can determine how well the net can catch specific types of fish. There is still room for improvement in that art.

### SUMMARY OF THE INVENTION

In view of the foregoing disadvantages inherent in the known devices now present in the prior art, the present invention, which will be described subsequently in greater detail, is to provide objects and advantages which are:

To provide for an improved cod-end for catching shrimps.

In order to do so, the invention is comprised of an outer net having a uniform thread gauge, and which is knotted such that square-shaped openings are formed in a side-by-side uniform pattern. An inner net having a uniform thread gauge that is smaller than the outer net thread gauge, and which is knotted such that lozenge-shaped openings are formed in a side-by-side uniform pattern, wherein the lozenge-shaped openings are each formed having an area that is smaller than an area defined by each the square-shaped opening, and wherein the inner net is placed upon an inner surface of the outer net forming the improved trawling net, such that the trawling net is thereby adapted to catch smaller fish and marine life than the outer net alone.

In one embodiment, the area of each the square-shaped opening is at least three times larger than the area of each the lozenge-shaped opening.

In another embodiment, the gauge of the outer net is at least twice the gauge of the inner net.

Generally, the improved trawling net forms a tear drop-shape, to thereby maximize the amount of fish and marine life held therein.

A portion of the outer net is adapted to be attached to a trawling fishing boat.

The improvement consists of a cod-end including an inner net having a uniform thread gauge that is smaller than the main net thread gauge, and is knotted such that lozenge-shaped openings are formed in a side-by-side uniform pattern, wherein the lozenge-shaped openings are each formed having an area that is smaller than an area defined by each the square-shaped opening; and wherein the inner net is placed upon an inner surface of the main net forming the cod end, such that the trawling net is thereby adapted to catch smaller fish and marine life than the main net alone.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Plan view of a cod-end section.

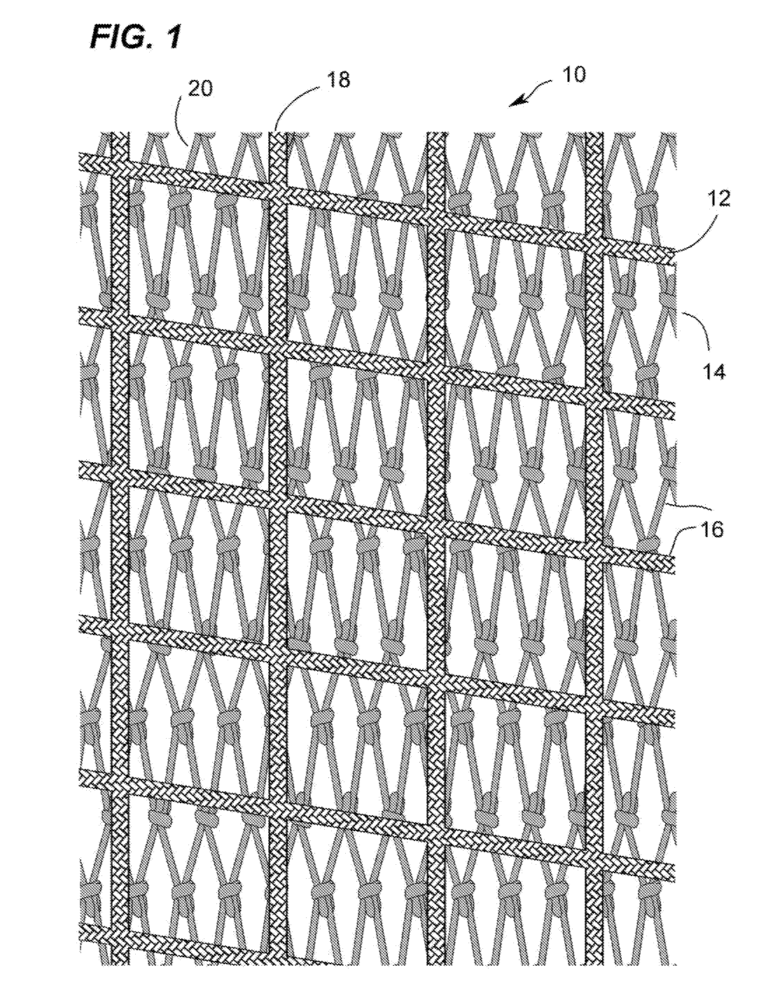

FIG. 2 Side cutaway view of a detail of a cod-end.

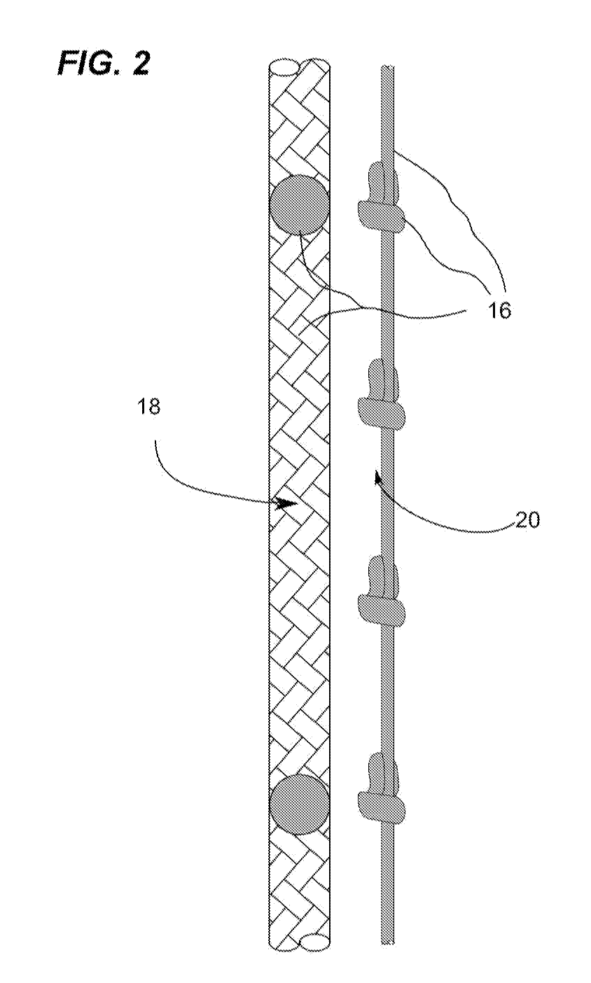

FIG. 3 Top view of a trawling net in context of use.

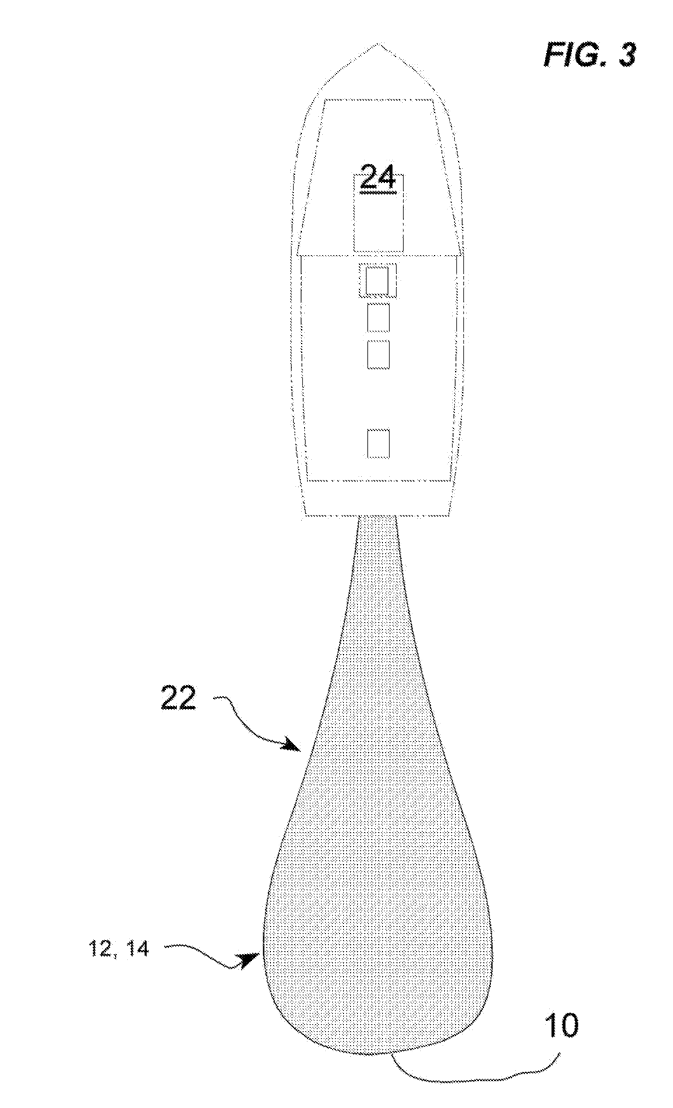

### DETAILED DESCRIPTION OF THE PREFERRED EMBODIMENT

An improved cod-end (10) for catching shrimps has an outer net (12) and an inner net (14). The outer net (12) has a thread (16) gauge that is substantially larger than the thread gauge of the inner net (14).

The outer net (12) is knotted so as to produce a plurality of square shaped openings (18) and the inner net (14) is knotted so as to produce a plurality of lozenge shaped openings (20).

Both nets (12, 14) are attached together by way knots in a fashion that is familiar to fishermen. Once attached, they extend into the rest of a trawling net (22). The trawling net (22) is itself attached to a trawling fishing boat (24) as is known in the art.

The outer net (12) is a knot less netting so as to produce a plurality of square shaped openings and the inner net (14) is either knotted or knot less so as to produce a plurality of lozenge shaped or T90 shaped openings. The two nets, together, form a tear drop-shape, to thereby maximize the amount of fish and marine life held therein

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An improved trawling net, said trawling net comprising an outer net having a uniform thread gauge, and is knotted such that square-shaped openings are formed in a side-by-side uniform pattern; and an inner net having a uniform thread gauge that is smaller than said outer net thread gauge, and is knotted such that lozenge-shaped openings are formed in a side-by-side uniform pattern, wherein said lozenge-shaped openings are each formed having an area that is smaller than an area defined by each said square-shaped opening; and wherein said inner net is placed upon an inner surface of said outer net forming said improved trawling net, such that said trawling net is thereby adapted to catch smaller fish and marine life than said outer net alone.

2. The improved trawling net of claim 1, wherein said area of each said square-shaped opening is at least three times larger than said area of each said lozenge-shaped opening.

3. The improved trawling net of claim 1, wherein said gauge of said outer net is at least twice the gauge of said inner net.

4. The improved trawling net of claim 1, wherein said improved trawling net forms a tear drop-shape, to thereby maximize the amount of fish and marine life held therein.

5. The improved trawling net of claim 1, wherein a portion of said outer net is adapted to be attached to a trawling fishing boat.

6. In a trawling net comprising a main net having a uniform thread gauge and knotted such that square-shaped openings are formed in a side-by-side uniform pattern, the improvement consisting of a cod-end including an inner net having a uniform thread gauge that is smaller than said main net thread gauge, and is knotted such that lozenge-shaped openings are formed in a side-by-side uniform pattern, wherein said lozenge-shaped openings are each formed having an area that is smaller than an area defined by each said square-shaped opening; and wherein said inner net is placed upon an inner surface of said main net forming said cod end, such that said trawling net is thereby adapted to catch smaller fish and marine life than said main net alone.

7. The trawling net of claim 6, wherein said area of each said square-shaped opening is at least three times larger than said area of each said lozenge-shaped opening.

8. The trawling net of claim 6, wherein said gauge of said main net is at least twice the gauge of said inner net.

9. The trawling net of claim 6, wherein said trawling net forms a tear drop-shape, to thereby maximize the amount of fish and marine life held therein.

10. The trawling net of claim 6, wherein a portion of said outer net is adapted to be attached to a trawling fishing boat.
